(19) United States
(12) Patent Application Publication
(10) Pub. No.: US 2007/0083896 A1
(43) Pub. Date: Apr. 12, 2007

(54) SYSTEM TO ALLOCATE AND PRIORITIZE RECORDINGS

(76) Inventor: Peter Ethan Staples, Los Angeles, CA (US)

Correspondence Address: SCHOX PLC, 209 N. MAIN STREET #200, ANN ARBOR, MI, 48104, US

(21) Appl. No.: 11/469,909

(22) Filed: Sep. 5, 2006

Related U.S. Application Data
(60) Provisional application No. 60/714,370, filed on Sep. 6, 2005.

(51) Int. Cl. H04N 5/445; H04N 7/16; H04N 7/173; G06F 3/00; G06F 13/00

(52) U.S. Cl. 725/58; 725/134; 725/142

(57) ABSTRACT

The system of the preferred embodiment includes multiple first sensors adapted to detect the state of a designated area, multiple second sensors adapted to detect changes or events within the designated area, multiple recording devices adapted to record information, a processor adapted to allocate recording resources and to prioritize the recorded information, and an output element adapted to display the recorded information. The processor connects the first sensors and second sensors to the recording devices and contains a storage device adapted to store the recorded information.

### CROSS-REFERENCE TO RELATED APPLICATIONS

This application claims the benefit of U.S. Provisional Application No. 60/714,370, filed 06 Sep. 2005 and entitled “System to Allocate and Prioritize Recordings”, which is incorporated in its entirety by this reference.

### TECHNICAL FIELD

This invention applies to the field of recording systems and, more specifically, to a recording system capable of allocating the recoding resources of the system and prioritizing the recorded information.

### BACKGROUND

Conventional recording systems record very large amounts of information in order to attempt to capture various events that may occur in a designated area. Continuous recoding and monitoring can be prohibitively expensive and time consuming. Additionally, by recording very large amounts of data, the system acquires far too much information to send to a display for monitoring and for a user to identify the important events. This invention provides a new and useful recording system that is capable of both allocating the recoding resources of the system and prioritizing the recorded information.

### BRIEF DESCRIPTION OF THE FIGURES

FIGS. 1, 2, and 3 are schematic views of various first sensors, second sensors, and recording devices of a preferred embodiment of the invention.

FIG. 4 is a schematic view of the output element of a preferred embodiment.

### DESCRIPTION OF THE PREFERRED EMBODIMENTS

The following description of the preferred embodiment of the invention is not intended to limit the invention to this preferred embodiment, but rather to enable any person skilled in the art to make and use this invention.

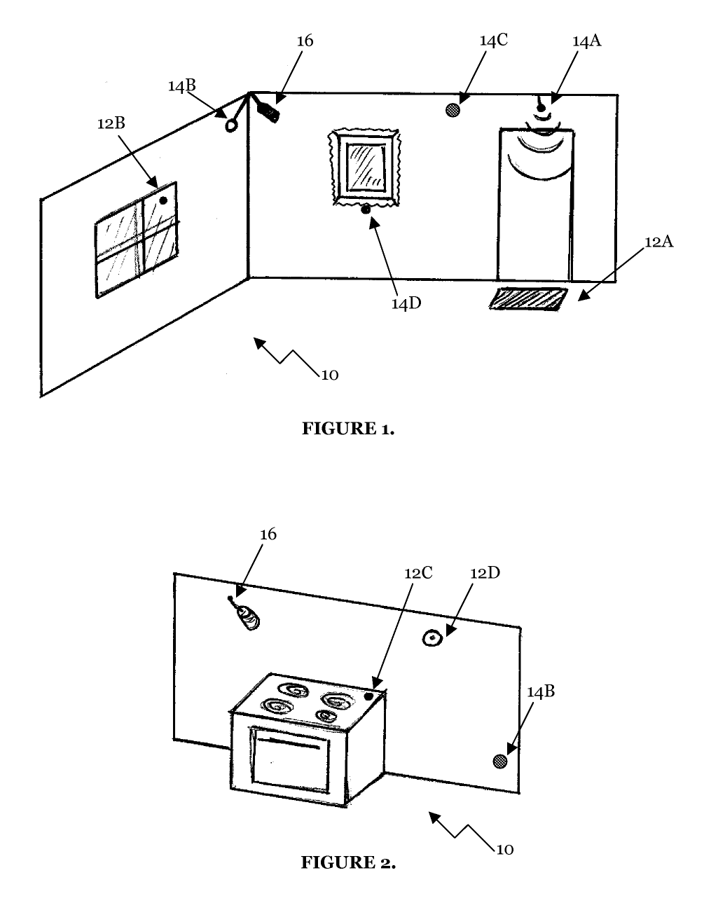

As shown in FIGS. 1-4, the system 10 of the preferred embodiment includes multiple first sensors 12 adapted to detect the state of a designated area, multiple second sensors 14 adapted to detect changes or events within the designated area, multiple recording devices 16 adapted to record information, a processor adapted to allocate recording resources and to prioritize the recorded information, and an output element 18 adapted to display the recorded information. The processor connects the first sensors 12 and second sensors 14 to the recording devices 16 and contains a storage device adapted to store the recorded information. The system 10 of the preferred embodiment has been specifically designed to be used and implemented in a home or a building. The system 10, however, may be used in any suitable environment and for any suitable reason.

As shown in FIGS. 1-3, the first sensor 12 of the preferred embodiment functions to detect the state of a designated area. The state of the designated area preferably refers to the presence or absence of a person or persons in the designated area, but may alternatively refer to any other suitable state. In a first variation, as shown in FIG. 1, the first sensor 12 is a pressure sensor 12A. The pressure sensor detects the presence of an entity such as a person, an animal, or an object by the presence of pressure on the sensor. The pressure sensor may detect the presence of something if the designated area is meant to be vacant, or alternatively may detect the absence of something in the designated area if the designated area is meant to be occupied. For example, the pressure sensor might detect the presence or absence of an object from its location, the presence or absence of a person in a room that is meant to be vacant, or the presence or absence of a child in a crib. The pressure sensor of this variation may be located or embedded in a floor, mattress, chair, toilet or any other suitable area where the detection of an entity such as a person, animal, or object is desired. The pressure sensor of this variation may alternatively be utilized to detect any other suitable state.

In a second variation, the first sensor 12 is one of several different ambient condition sensors. As shown in FIG. 1, first sensor 12 is a rain sensor 12B that detects rain outside of a window. As shown in FIG. 2, first sensor 12 is a temperature sensor 12C that detects the on or off state of a stove. The first sensor 12 can also be a smoke detector 12D that detects the presence or absence of smoke. As shown in FIG. 3, the first sensor 12 is an alcohol sensor 12E that may be located in an instrument panel of a vehicle to detect the presence of alcohol in the breath of a driver. The ambient condition sensor may be a rain sensor, a carbon monoxide sensor, a dust sensor, a water or water level sensor, a humidity sensor, a temperature sensor, a light sensor, a methane sensor, a smoke detector, a wind sensor, or any other suitable device to detect any suitable ambient condition. Although the first sensor 12 is preferably one of these variations, the first sensor 12 may be any suitable device or method to detect the state of a designated area.

As shown in FIGS. 1-3, the second sensor 14 of the preferred embodiment functions to detect changes or events within a designated area. In a first variation, as shown in FIG. 1, the second sensor 14 is an infra-red (IR) beam 14A. The IR beam 14A detects the passage of an entity such as a person, animal, or other object. The IR beam may be located at doors or hallways or any other suitable location to detect the passing of a person, animal, or other object through the beam. A double IR beam may be utilized to determine the direction of the movement. The IR beam is preferably a conventional IR beam but may alternatively be any suitable device to detect the passage of a person, animal, or object.

In a second variation, as shown in FIGS. 1-3 the second sensor 14 is a motion detector 14B. The motion detector is preferably a passive infrared (PIR) sensor. The PIR sensor detects changes in the infrared energy (or radiant heat) emitted by the person or persons, or any other heat-emitting object. The PIR sensor is also able to detect changes in IR energy relative to the number of people present in the designated area. The motion detector 14B may alternatively emit microwave energy or ultrasonic sound waves to detect motion, it may be a pyroelectric sensor, an IR or light beam coupled with a photosensor, or it may be any other suitable device or method to detect the changes in energy in a designated area. The motion detector may alternatively include a vibration sensor, an accelerometer, a speedometer, or any other suitable device that is able to detect the change in position of an object. In a third variation, as shown in FIG. 1, the motion detector is an accelerometer 14D attached to an object that functions to detect the movement of the object. The motion detector may also be able to detect the opening of a window or door, or the sudden shaking caused by an earthquake, or any other suitable event.

In a fourth and fifth variation, the second sensor 14 is an ambient condition sensor. As shown in FIG. 1, the second sensor 14 is a sound meter 14C. In this fourth variation, the sound meter 14C detects the changes in sound. The sound meter may be a microphone or alternatively any other suitable device to measure sound levels. In this variation, the second sensor 14 may detect changes in volume, such as the event of a broken window, a car alarm, or any other suitable event that involves sound. In a fifth variation, the second sensor 14 is a Carbon Dioxide (CO₂) detector that detects the increased levels of CO₂ due to the exhalation of a person or animal.

In a sixth variation, the second sensor 14 is a vital sign sensor that functions to detect various vital signs such as heart beat, breathing rate, temperature, blood pressure, oxygen saturation levels of the blood, and any other suitable physical sign. The second sensor 14 in this variation could monitor such vital signs and detect when they are in healthy ranges, unhealthy ranges, or when an emergency is occurring. The second sensors 14 in this variation may be located in a bed, hospital room, child's crib, pet's bed, or any other suitable location.

In a seventh variation, the second sensor 14 is an electrical sensor that detects changes in the connection or power over a phone line or power line or any other suitable event relating to current flow or voltage change. Although the second sensor 14 is preferably one of these seven variations, the second sensor 14 may be any suitable device or method to detect any suitable event. In alternative variations, the system 10 may include any suitable combination or permutation of the above first sensors 12 and second sensors 14 to determine any suitable state and detect any suitable event. Table 1 includes a partial list of potential sensor combinations.

| Sensor 1 | Sensor 2 | Target Scenario |
|---|---|---|
| IR beam | PIR or CO₂ | rooms that include people |
| sound meter | IR beam | rooms that include people |
| IR beam | IR beam | moving objects based on their |
| | | height |
| IR temp sensor | one of the above | stove if turned on and house |
| | combos | empty |
| pressure sensor | PIR | rooms that include people |
| wind sensor | PIR | tornado or hurricane |
| CO sensor | PIR | excess CO |
| smoke detect. | PIR | smoke in the air |
| temp sensor | PIR | fire |
| vibration sensor | PIR | earthquake |
| flow meter | PIR | water flow |
| current sensor | PIR | non-functioning phone line |
| current sensor | PIR | non-functioning phone line |
| PIR | hall effect | window opened from the outside |
| PIR | vibration sensor | window opened from the outside |
| sound meter | vibration sensor | window broken |
| vibration sensor | photosensor | termites |
| tilt sensor | photosensor | garage if garage door is open at |
| | | night |
| pair of dust | hall effect | outdoor air is dirtier than indoor |
| sensors | | air and window is open |
| pair of temp | hall effect | outdoor air is warmer than indoor |
| sensors | | air and window is open |
| pair humidity | hall effect | outdoor air is more humid than |
| sensors | | indoor air and window is open |
| rain sensor | hall effect | window if open during rain |
| sound meter | light sensor | objects in the dark and loud |
| | | sounds |

As shown in FIGS. 1-3, the recording device 16 of the preferred embodiment functions to record information. The recording device 16 is preferably one of several variations. In a first variation, the recording device 16 includes a camera that functions to record video or still frame information. The camera is preferably a conventional camera that records visual light waves, but may be any suitable device able to record images (using visual light waves, IR waves, or other suitable methods). The recording device 16 may be coupled with an illumination device, such as a spotlight, that can emit visual light waves, IR waves, or other suitable waves. In a second variation, the recording device 16 includes a microphone that functions to record audio information. The microphone is preferably a conventional microphone, but may be any suitable device able to record sound. Although there are certain advantages to these particular variations, the recording device 16 may take any suitable form.

In the preferred embodiment, the system 10 also contains a storage device. The storage device of the preferred embodiment functions to store the recorded information from the recording device 16. The storage device is preferably a conventional memory chip, such as RAM, a hard drive, or a flash drive, but may alternatively be any suitable device able to store information.

The processor of the preferred embodiment functions to allocate the recording resources of the system 10 and to prioritize the recorded information. The processor is preferably a conventional processor, but may alternatively be any suitable device to perform the desired functions. In a first variation, the processor functions to allocate the recording resources by using the information from the first sensors 12 and second sensors 14 to determine if and when the recording devices 16 should be activated. The processor preferably activates the recording device 16 when the first sensor 12 detects a predetermined state in a designated area. The processor may further modify the recording mode of the recoding device 16 such as control the pan, zoom, rotate or any other suitable function of the recording device 16 based on the state or events detected by the first sensors 12 and second sensors 14, respectively, so that the recording device 16 may more effectively record the event of interest. The recording device 16 is activated and records information to the storage device of the processor when the first sensors 12 and second sensors 14 have established states and events to which the processor has been set to allocate recording resources. In a second variation, the recording device 16 records on a continual basis and the processor functions to allocate the storages resources by using the information from the first sensors 12 and second sensors 14 to determine if the recorded information should be flagged and kept or deleted after a predetermined time period. The processor flags all events detected by the second sensors 14 and a still frame or a recording of a given length surrounding the event is recorded to the storage device.

The processor further functions to connect the first sensors 12 and second sensors 14 to the recording devices 16. The first sensors 12 and second sensors 14, the processor, and the recording devices 16 may be connected through a system of wires, or preferably, by means of a wireless device. The wireless device may function to connect any suitable combination of first sensors 12, second sensors 14, recording devices 16, and a processor. The wireless device may also function to connect the system 10 to another adjacent system 10, or may function to connect the system 10 to a larger network, such as a ZigBee network, a Bluetooth network, an Internet-protocol based network, or a cellular network.

The processor further functions to connect to the output element 18. In a first variation, the processor transmits all of the recorded information (on a “live” basis) to the output element 18, but preferably signals the viewer (through a light source or any other appropriate device or method) when the information has been flagged. In a second variation, the processor transmits only the flagged and recorded information to the output element 18. The recorded information is displayed by the output element 18 in a highly efficient manner, based on the established priority. The processor may be connected to the output element 18 through a system of wires, phone lines, or by means of a wireless device. The wireless device may function to connect the processor to a local output element 18, or may function to connect the processor to output element 18 on a larger network, such as a ZigBee network, a Bluetooth network, an Internet-protocol based network, or cellular network.

The processor further functions to code and/or compress the recorded information. The processor may encrypt, encode, scramble, or may, by any other suitable means, protect and secure the recorded information of the system 10. The processor preferably uses the MPEG-4 compression formats, but may alternatively use any suitable compression format.

In an alternative embodiment, the processor may be adapted to receive feedback from another source (such as a human) and to learn and/or adapt the “flagging” process based on this feedback.

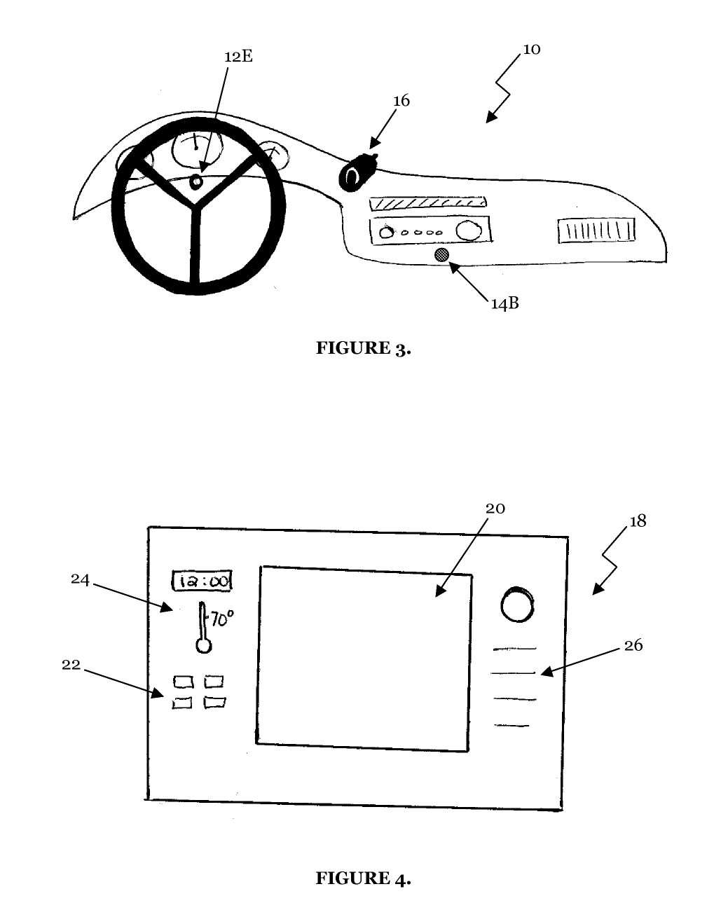

As shown in FIG. 4, the output element 18 of the preferred embodiment functions to display the recorded information. In a first variation, the recorded information may be displayed real-time such that the highest priority rooms or designated areas are shown. If there are multiple rooms or designated areas that are simultaneously of high priority, the recorded information may be displayed in a split screen format. In a second variation, the recorded information is displayed in a report format. The report is preferably generated at the end of a designated period, but may be generated based on the flagged information. The report preferably includes the states and/or events of the designated areas, a sequence of short recordings or a storyboard of still frames related to the flagged events, and any other suitable information. The report is preferably compiled and sorted by time stamps and/or priority levels. At any time, recorded information from given states or events may be accessed and viewed repeatedly, viewed for a longer period of time surrounding the event, or viewed in more detail. The recorded information may be displayed in any suitable combination or permutation of the real-time display or report as described above.

The output element 18 of the preferred embodiment is preferably one of several variations, but may consist of any suitable device or method by which to display the recorded information as described above. In a first variation, as shown in FIG. 4, the output element 18 is a physical display unit. The display unit may include a screen 20, controls 22, condition outputs 24, speakers 26, indicators, or any other suitable devices or methods to display recorded information or to accept user inputs.

In a second variation, the output element 18 is a network device. In this variation, the output element 18 is a browser or other suitable application with an Internet connection, an Internet email, or any other suitable device or method to display the recorded information in any suitable combination or permutation of the real-time display or report over a network device. In this variation it is possible to send an alert email at the occurrence of high priority states or events. In this variation, it is also possible to transmit the recorded information over the Internet to a third party that may monitor the recorded information.

In a third variation, the output element 18 is a phone call or message to a pager. In this variation, the system 10 may display the recorded information in the form of an alert message to a phone, answering machine, pager or any other suitable device. The alert message may be sent to the owner or user of the system 10 or directly to the fire, police, medic or other suitable emergency services. With this system, a minimal number of humans can effectively monitor multiple homes, buildings, or facilities.

The system 10 of the preferred embodiment may also include elements that may be remotely controlled. The elements may preferably include doors or windows to be opened, closed, locked or unlocked; power switches to be turned on or off; water valves to be turned opened or closed; or any other suitable element to be controlled remotely. For example, if the system 10 displays recorded information that a window is open and that it is raining outside, the owner or user of the system 10 may remotely control the widow and close it. Further, if the system 10 displays recorded information that the stove is on and that the kitchen is vacant, the owner or user may remotely control the stove and cut the power to the stove. The recorded information may be of any other suitable state or event and the remotely controlled element may alternatively be any other suitable element.

The system 10 may further function to record information for personal and entertainment purposes. For example, during family or friendly gatherings, important events, or any other suitable event, the system 10 may record information. The user may then later view the display of the recorded information and may choose any event of interest and view the recorded information around that event. Important, comical, or memorable events will no longer be missed as the system 10 may be set to record them.

Although omitted for conciseness, the preferred embodiments include every combination and permutation of the various first sensors 12, the various second sensors 14, the various recording devices 16, the various processors and storage devices, and the various output elements 18.

As a person skilled in the art will recognize from the previous detailed description and from the figures and claims, modifications and changes can be made to the preferred embodiment of the invention without departing from the scope of this invention defined in the following claims.

I claim:

1. A system to allocate and prioritize recordings, comprising:
a first sensor adapted to detect a state of a designated area;
a recording device adapted to record information; and
a processor coupled to the first sensor and the recording device, and adapted to prioritize the recorded information based on the state detected by the first sensor at the time that the information is recorded and to transmit the prioritized recorded information to an output element.

2. The system to allocate and prioritize recordings of claim 1 wherein the first sensor is an accelerometer that is coupled to an object to be monitored and adapted to detect when the object moves.

3. The system to allocate and prioritize recordings of claim 2 wherein the processor is adapted to give high priority to the information recorded when the first sensor detects that the object is moving.

4. The system to allocate and prioritize recordings of claim 1 wherein the recording device is a camera adapted to record at least one still frame.

5. The system to allocate and prioritize recordings of claim 4 wherein the recording device further includes a device to record environmental parameters.

6. The system to allocate and prioritize recordings of claim 1 further comprising an output element including at least one of the following: a screen, an indicator, and a speaker.

7. The system to allocate and prioritize recordings of claim 1 wherein the processor is adapted to transmit the prioritized recorded information to an output element via a network.

8. The system to allocate and prioritize recordings of claim 1 wherein the processor is further adapted perform at least one of the following: coding, compressing, and encrypting the recorded information.

9. The system to allocate and prioritize recordings of claim 1 wherein the processor further includes a wireless device adapted to couple the sensor and the recording device.

10. The system to allocate and prioritize recordings of claim 1 wherein the processor is adapted to transmit only a portion of the recorded information to the output element.

11. The system to allocate and prioritize recordings of claim 10 wherein the processor is adapted to transmit only a portion of the recorded information to the output element based on the priority of the recorded information.

12. The system to allocate and prioritize recordings of claim 1 further comprising a storage device adapted to store recorded information from the recording device, and wherein the processor is further adapted to control the storage device in the following modes:
storage mode—wherein the processor activates the storage device to store the recorded information when the sensor detects a predetermined state; and
non-storage mode—wherein the processor deactivates the storage device to not store the recorded information.

13. The system to allocate and prioritize recordings of claim 1 further comprising a second sensor adapted to detect an event in a designated area wherein the processor is coupled to the second sensor and is further adapted to prioritize the recorded information based on the state detected by the first sensor and the event detected by the second sensor, and is further adapted to allocate the recording resources of the system by controlling the recording device in the following modes:
record mode—wherein processor activates the recording device to record information when the first sensor detects a predetermined state;
modified record mode—wherein the processor modifies the record mode of the recording device when the second sensor detects a predetermined event;
non-record mode—wherein processor deactivates the recording device to not record information.

14. The system to allocate and prioritize recordings of claim 13 wherein the first sensor is a pressure sensor adapted to detect the presence of a person in a bed and the second sensor is a vital sign sensor adapted to monitor physical signs of the person.

15. The system to allocate and prioritize recordings of claim 14 wherein the processor is adapted to activate the recording device to record and to give high priority to the information recorded when the first sensor detects that there is a person in the bed and the second sensor detects the change of the person's vital signs.

16. The system to allocate and prioritize recordings of claim 1 wherein the processor is further adapted to generate reports.

17. The system to allocate and prioritize recordings of claim 16 wherein the reports are compiled and sorted by time stamps and priority levels.

18. The system to allocate and prioritize recordings of claim 17 wherein the reports includes the states detected by the first sensor, the events detected by the second sensors.

19. The system to allocate and prioritize recordings of claim 18 wherein the report includes one of the following: a sequence of short recordings related to the prioritized recorded information, and a storyboard of still frames related to the prioritized recorded information.
